(19) United States
(12) Patent Application Publication
(10) Pub. No.: US 2016/0171006 A1
(43) Pub. Date: Jun. 16, 2016

(54) MOBILE TERMINAL AND METHOD FOR CONTROLLING THE SAME

(71) Applicant: LG ELECTRONICS INC., Seoul (KR)

(72) Inventors: Jonghwan KIM, Seoul (KR); Hyungjin KIM, Seoul (KR); Yunmi KWON, Seoul (KR)

(21) Appl. No.: 14/959,546

(22) Filed: Dec. 4, 2015

(30) Foreign Application Priority Data
Dec. 15, 2014 (KR) 10-2014-0180571

(51) Int. Cl. G06F 17/30

(52) U.S. Cl. CPC G06F 17/3087; G06F 17/3089; G06F 17/30554

(57) ABSTRACT

Embodiments may relate to a mobile terminal configured to provide an indicator indicating whether location information is included in a search result received from a web search engine and a method of controlling therefor. Specifically, the mobile terminal according to embodiments may include a touch screen configured to output an execution screen of a web browser application and a controller configured to provide a search query to a web search engine based on an input at a search field, to receive one or more web search results from the web search engine in response to the search query, to control the touch screen to display a web search list containing the one or more web search results and a location information indicator, the location information indicator to identify that location information is provided in the web search list.

### CROSS-REFERENCE TO RELATED APPLICATION(S)

Pursuant to 35 U.S.C. §119(a), this application claims the benefit of earlier filing date and right of priority to Korean Application No. 10-2014-0180571, filed on Dec. 15, 2014, the contents of which are hereby incorporated by reference herein in their entirety.

### BACKGROUND

1. Field

Embodiments may relate to a mobile terminal enabling a user to more conveniently use the terminal and a method of controlling therefor.

2. Background

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

A user accesses a web search engine such as Google, Bing and the like using a terminal and may be able to use a web search service provided by the web search engine. The web search service just corresponds to a service simply outputting a list (search list) of web pages matched with a search keyword and the service connecting to a URL (uniform resource locator) when a specific web page is touched on the list of the web pages.

Recently, web pages provide various contents in combination and location information is included in the various contents. Although various contents are included in a web page, when a search list for the web page is provided, if information on contents is not included in the search list, a user may feel inconvenience. Hence, it is necessary to have a method capable of identifying the contents included in the web page and providing the contents together with the search list.

### BRIEF DESCRIPTION OF THE DRAWINGS

The embodiments will be described in detail with reference to the following drawings in which like reference numerals refer to like elements wherein:

FIG. 1A is a block diagram of a mobile terminal in accordance with the present disclosure;

FIGS. 1B and 1C are conceptual views of one example of the mobile terminal, viewed from different directions;

FIG. 2 is a flowchart for a control method indicating whether location information content is included in a web search list according to one embodiment;

FIG. 3 is a diagram of a state displaying a location information indicator indicating whether location information content is included in a web search list according to one embodiment;

FIG. 4 is a diagram for a control method of outputting a web page in case that a prescribed item is selected from a search list according to one embodiment;

FIG. 5 is a diagram for a control method of outputting location information-related items only on a search list provided by a web search engine in a manner of filtering the location information-related items according to one embodiment;

FIG. 6 is a diagram for a control method of displaying a location in which location information content is included on a scroll bar configured to scroll a web page according to one embodiment;

FIG. 7 is a diagram for a control method of separately displaying a location information indicator for a search list deviating from an output range of a touch screen 151 according to one embodiment;

FIG. 8 is a diagram for a control method of guiding location information included in a web page in case that the web page is stored by “offline view” function according to one embodiment;

FIG. 9 is a diagram for a control method of transmitting location information content included in a prescribed content together in case that the prescribed content is transmitted to a different mobile terminal according to one embodiment;

FIG. 10 is a diagram for a control method of selectively transmitting a web page 400 and content included in the web page according to one embodiment;

FIGS. 11 and 12 are diagrams for a control method of providing weather information corresponding to location information together with the location information according to one embodiment;

FIG. 13 is a diagram for a control method enabling a user to directly access location information provided on a search list according to one embodiment;

FIG. 14 is a diagram for a control method of reading a web page item stored in a memory 170;

FIG. 15 is a diagram for a control method of storing location information corresponding to a prescribed web page 400 by a user input according to one embodiment;

FIG. 16 is a diagram for a control method enabling a user to directly access location information provided on a search list according to a different embodiment;

FIG. 17 is a diagram for a control method of providing a notification of location information to a user based on a current location of a mobile terminal 100 according to one embodiment.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

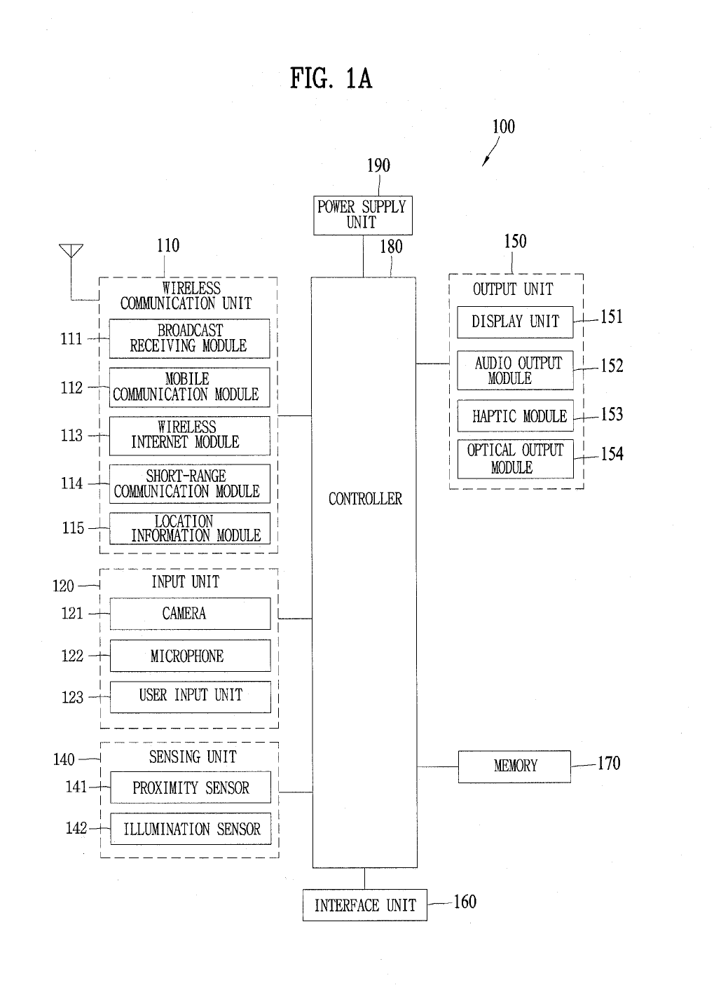

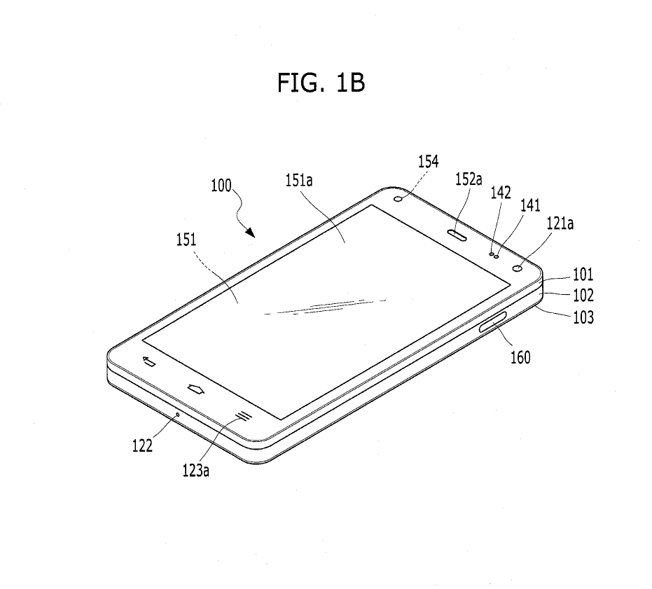

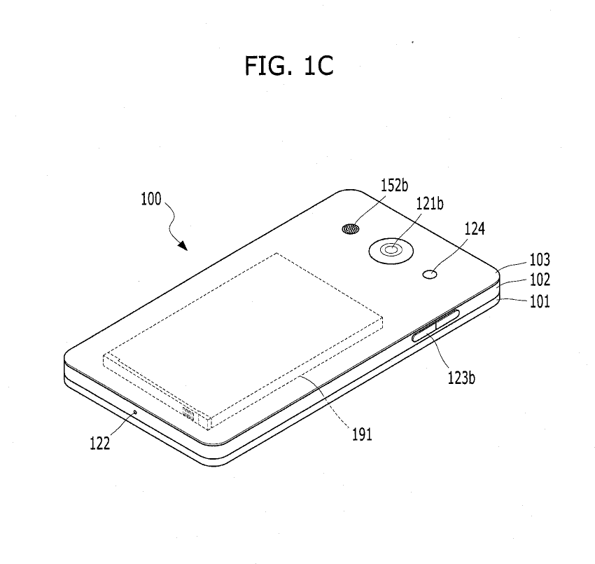

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, informations and the like inputted or outputted through the above-mentioned components and/or runs application programs saved in the memory 170, thereby processing or providing a user with appropriate informations and/or functions.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the 1st audio output unit 152a, the 2nd audio output unit 152b, the proximity sensor 141, the illumination sensor 142, the light output unit 154, the 1st camera 121a, the 2nd camera 121b, the 1st manipulating unit 123a, the 2nd manipulating unit 123b, the microphone 122, the interface unit 160, and the like.

FIGS. 1B and 1C depict certain components as arranged on the mobile terminal.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be movable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160.

Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Further preferred embodiments will be described in more detail with reference to additional drawing figures. It is understood by those skilled in the art that the present features can be embodied in several forms without departing from the characteristics thereof.

A web search engine indicates a software system designed to search for information of WWW (World Wide Web). Before a market of a mobile terminal is expanded, users have used a service of the web search engine using a PC (personal computer).

Recently, as the use of a mobile terminal is rapidly increasing in a manner of disseminating a huge amount of smartphones, percentage of the use of a web search engine using the mobile terminal is also increasing.

In case of using the service via a mobile terminal, it is able to not only access a web page of the web search engine using a web browser application but also access the web search engine via an application provided by the web search engine itself.

Meanwhile, services or contents provided on a web page have changed as well. Images or texts used to be provided on a legacy web page as main contents. Yet, not only the images or the texts but also such metadata as location information, tag information and the like are provided on a recent web page.

Location information corresponds to a geographical location. Similar to what is used in a GPS, the location information consists of longitude and latitude. Not only the longitude and the latitude, location information (address and the like) of an administrative district may correspond to the location information as well.

For instance, in case of a web page displaying information on a specific restaurant, the web page can include a picture of the specific restaurant, a picture (image content) of food of the restaurant and explanation (text contents) on the pictures. Additionally, location of the restaurant can be included in the location information content.

As mentioned in the foregoing description, while the recent web page provides various contents, a search result provided by the web search engine does not include information on the contents, thereby causing inconvenience. Hence, one embodiment described in the following proposes to provide the information on the various contents on a service provided by the web search engine. In the following, a specific embodiment is explained with reference to drawings.

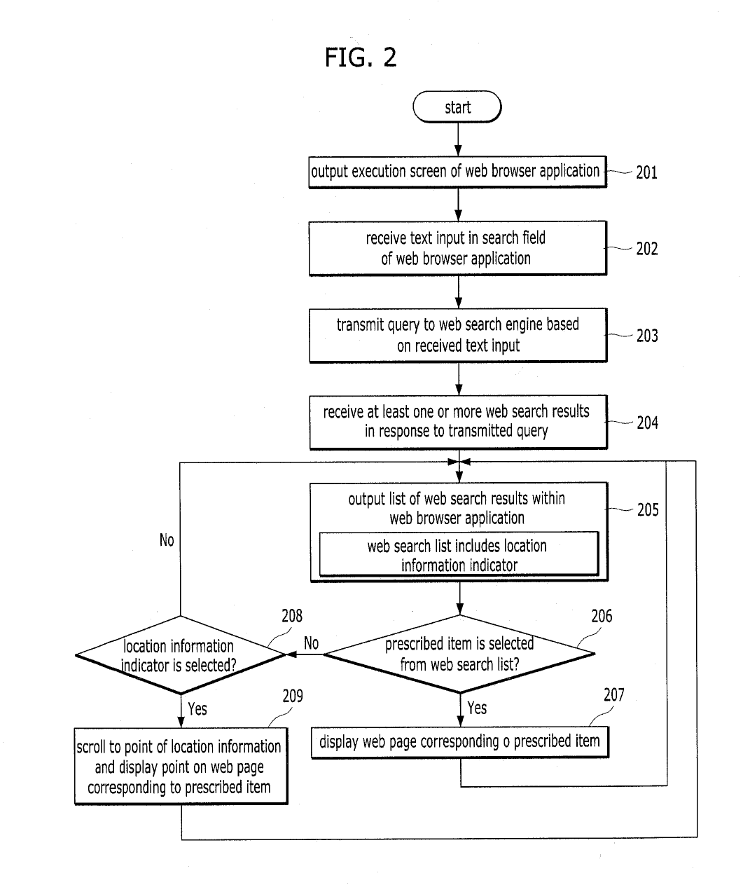

FIG. 2 is a flowchart for a control method indicating whether location information content is included in a web search list according to one embodiment.

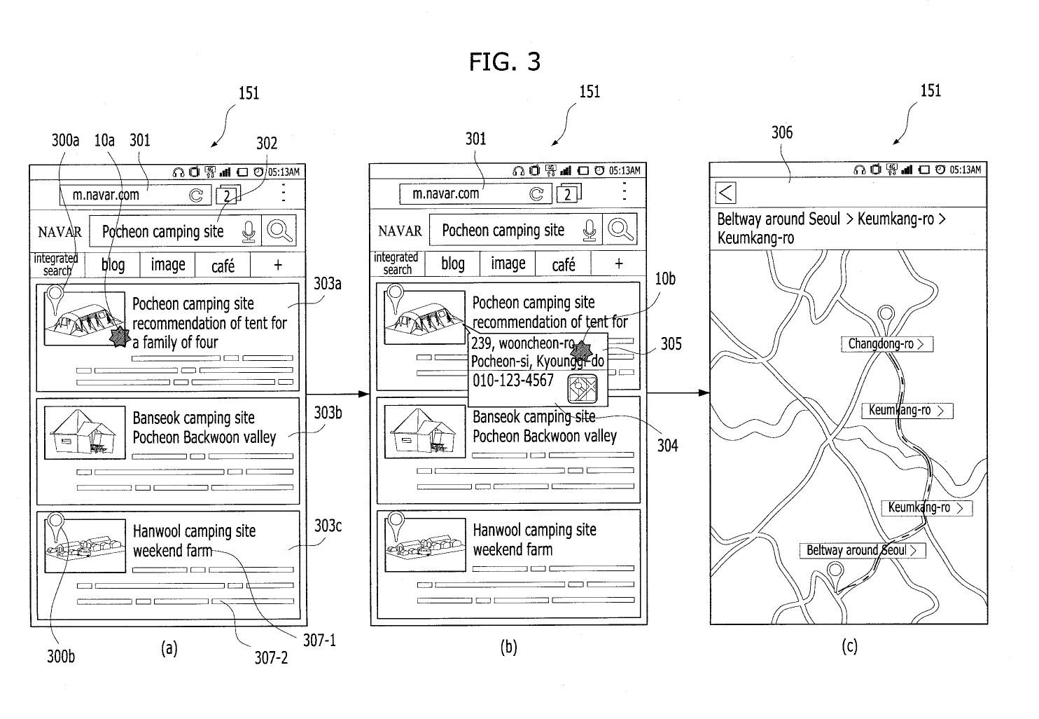

FIG. 3 is a diagram of a state displaying a location information indicator indicating whether location information content is included in a web search list according to one embodiment. In the following, the embodiment is explained with reference to FIG. 2 and FIG. 3 together.

In the step S201, the controller 180 outputs an execution screen 301 of a web browser application. The web browser application corresponds to an application for loading and outputting a web page and includes various types of applications including Safari, Internet explorer, Chrome and the like, by which the embodiments may be non-limited.

In case of accessing a web page of a web search engine via the web browser application, there may exist a search field (or a search word field) for receiving an input of a search word. The web browser application can transmit a query to the web search engine based on a keyword inputted in the search field [S203]. Subsequently, the web search engine searches for information of WWW using the keyword of the received query and may be able to provide a search result to the web browser application again.

Referring to FIG. 3(a), if the web browser application receives the search result [S204], the web browser application can output a list of the search result.

A state diagram of FIG. 3(a) is explained in more detail in the following. FIG. 3(a) shows a result state that such a keyword 302 as “Pocheon camping site” is inputted in a specific web search engine using a specific web browser application. The result state includes a list of result items (303a, 303b, 303c . . . ) searched by the keyword 302 such as “Pocheon camping site”.

In this case, the result items (303a, 303b, 303c . . . ) may correspond to a search result of a specific web page. As mentioned in the foregoing description, if location information content is included in a specific web page, one embodiment proposes to output a prescribed indicator (hereinafter, location information indicator) indicating that the location information content is included in a corresponding item on an outputted result list.

In the example shown in FIG. 3, assume that a first web page item 303a and a third web page item 303c include location information content and a second web page item 303b does not include location information content among the outputted result items (303a, 303b, 303c . . . ).

Hence, referring to FIG. 3(a), a first and a second location information indicator 300a/300b are displayed on the first and the third web page item 303a/303c, respectively. In the following, the location information indicator is represented as 300a, 303b, . . . , the location information indicators are commonly called 300 and web page items are commonly called 303.

The result item 303 can include at least one selected from the group consisting of a thumbnail image 307-1 for a representative image of a searched web page, a title 307-2 of the searched web page and a preview 307-3 of text contents of the searched web page. In this case, the location information indicator 300 can be displayed on the thumbnail image 307-1 of each result item 303 in a manner of being overlaid on the thumbnail image, displayed in the vicinity of the title 307-2 or can be outputted at a front end or a rear end of the text content preview 307-3. In particular, when the location information indicator is displayed in the vicinity of the title 307-2, if a specific search word (e.g., ‘Pocheon camping site’) is included in the title 307-2, the location information indicator 300 can be displayed in the vicinity of the specific search word.

In general, if a prescribed item is selected (touched) from a list of results searched by a web search engine [S206], it is able to display a web page using URL corresponding to the prescribed item [S207]. In particular, a function of loading and outputting the web page is provided only. As mentioned in the following description, according to one embodiment, various functions can be provided on a search list.

Referring to FIG. 3(a), if a prescribed touch gesture 10a is received on a location information indicator 300, the controller 180 can further output a preview 304 of location information content 305 corresponding to the location information indicator (refer to FIG. 3(b)). As an example of the prescribed touch gesture 10a, there exists a touch (touch hold) touching the location information indicator 300 for more than prescribed time or a proximity touch input on the location information indicator 300.

Referring to FIG. 3(b), the location information content 305 corresponds to address information, by which the embodiment may be non-limited.

Meanwhile, the preview 304 can be outputted in various forms.

According to one embodiment, as shown in FIG. 3(b), the preview 304 can be outputted on a partial/all area of a touch screen 151 in a form of a pop-up window. In particular, if a prescribed touch gesture 10a is received on a location information indicator 300, the controller 180 can output a pop-up window including the preview 304.

According to a different embodiment, a position at which a first web page item 303a is outputted and a position at which a second web page item 303b is outputted are adjusted (a space between the two items is adjusted to be widened) and the preview 304 can be outputted between the two web page items 303a/303b.

Meanwhile, a form of outputting the preview 304 may be non-limited by the aforementioned example. Embodiments may be applied to various methods of displaying the preview 304.

Referring to FIG. 3(c), moreover, if an input 10b for selecting location information content 305 included in the preview 304 is received, it may be able to immediately link to a map application and display a corresponding location to make the location to be identified. Or, it may be able to guide a moving path to the corresponding location.

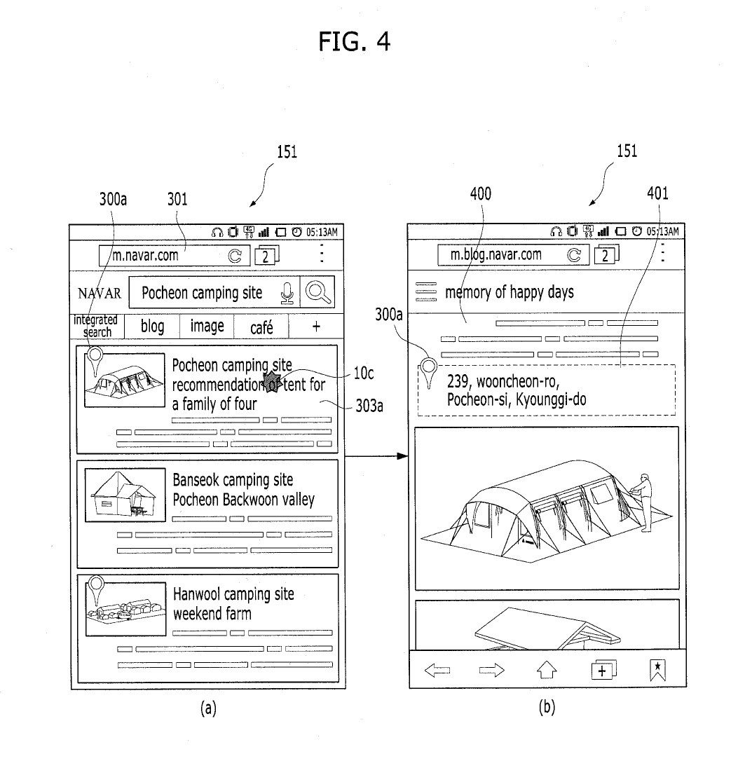

FIG. 4 is a diagram for a control method of outputting a web page in case that a prescribed item is selected from a search list according to one embodiment.

When a web page including location information content is outputted, one embodiment proposes to emphatically display a position on which the location information content is displayed (display the position in a manner of being identified). This is because importance of the location information content is higher compared to other contents.

Referring to FIG. 4(a), if an input 10c for selecting a first web page item 303a from a search list searched by a prescribed keyword is received [S206], the controller 180 can output a corresponding web page 400 [S207]. If location information exists on the outputted web page 400, the controller 180 can distinctively display the location information 401. And, the controller can also output a location information indicator 300a in the vicinity of the location information, which is distinctively displayed.

Meanwhile, whether or not location information is included in a prescribed web page 400 can be determined in various ways. The controller 180 according to one embodiment may determine (1) whether location information of a text form (address information, coordinate information written in a text form) is included in text content, (2) whether coordinate information (longitude and latitude information of a GPS) usable for a map application and the like is included in a metadata form, (3) whether location information is included in the web page 400 as a metadata of an attached image, and (4) whether location information is included in a header of a source code or a random field of the web page. As a result of the determination, if location information is included in the web page, the controller can distinctively display a corresponding location. For instance, if it is determined as location information is included in text content, the controller 180 can distinctively display a position on which the text content is outputted on the web page 400.

Referring to FIG. 4(b), location information of an address form is displayed by text for location information content 401, by which the embodiments may be non-limited. The location information content can also be outputted in a form of a map and a form of displaying a corresponding location on the map on a partial area of a web page.

Referring back to FIG. 2, the controller 180 determines whether a location information indicator 300 is selected [S208]. As a result of the determination, if the location information indicator 300 is not selected, it may be able to return to the step S205 again. If the location information indicator 300 is selected, it may proceed to the step S209. In the step S209, the controller 180 outputs a web page corresponding to the selected location information indicator 300 and may be able to output the web page in a manner of automatically scrolling the web page to display corresponding location information.

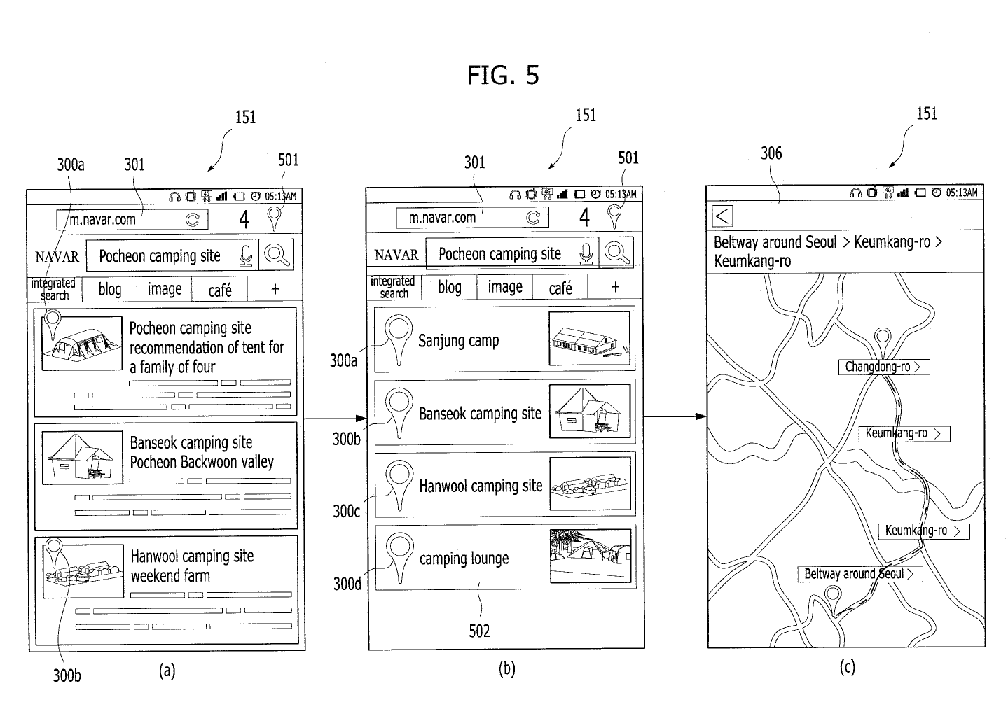

Meanwhile, when many result items are included in the search list, if location information is collected only, a user may be able to conveniently read the result items. Hence, one embodiment provides a control method for providing location information in a manner of collecting the location information in a search list. Regarding this embodiment, it shall be described in detail with reference to FIG. 5 in the following.

FIG. 5 is a diagram for a control method of outputting location information-related items only on a search list provided by a web search engine in a manner of filtering the location information-related items according to one embodiment.

Referring to FIG. 5(a), the controller 180 outputs a search list on an execution screen 301 of a web browser application and location information indicators 300a/300b are displayed on the search list. One embodiment proposes to further display the number 501 of the location information indicators 300 included in the search list.

According to one embodiment, the number 501 is provided by a web search engine and can be provided together with an output of a search list outputted on the web search engine by a web browser application. Yet, according to a different embodiment, the number 501 is counted by the controller 180 and the counted number 501 can be outputted on an area (e.g., as shown in FIG. 5(a), an area adjacent to a URL input window) of an execution screen 301 of the web browser application. If a control region including at least one or more functions of the web browser application is outputted, it is able to control the number 501 to be outputted on the control region according to one embodiment.

Referring to FIG. 5(b), if a prescribed touch gesture is received, the controller 180 can output a list 502 consisting of (filtered) search items including location information only on the search list. As an example, the prescribed touch gesture may correspond to an input touching the displayed number 501.

Each item of the filtered list 502 can also display a location information indicator 300a/300b/300c/300d and may be able to display a location name or a representative image.

Referring to FIG. 5(c), moreover, if an input for selecting one of the location information indicators 300 included in the filtered list 502 is received, the controller may be able to immediately link to a map application and distinctively display a corresponding location. Or, the controller may be able to guide a moving path to the location.

In the following, a control method for efficiently displaying location information content in a web page is explained.

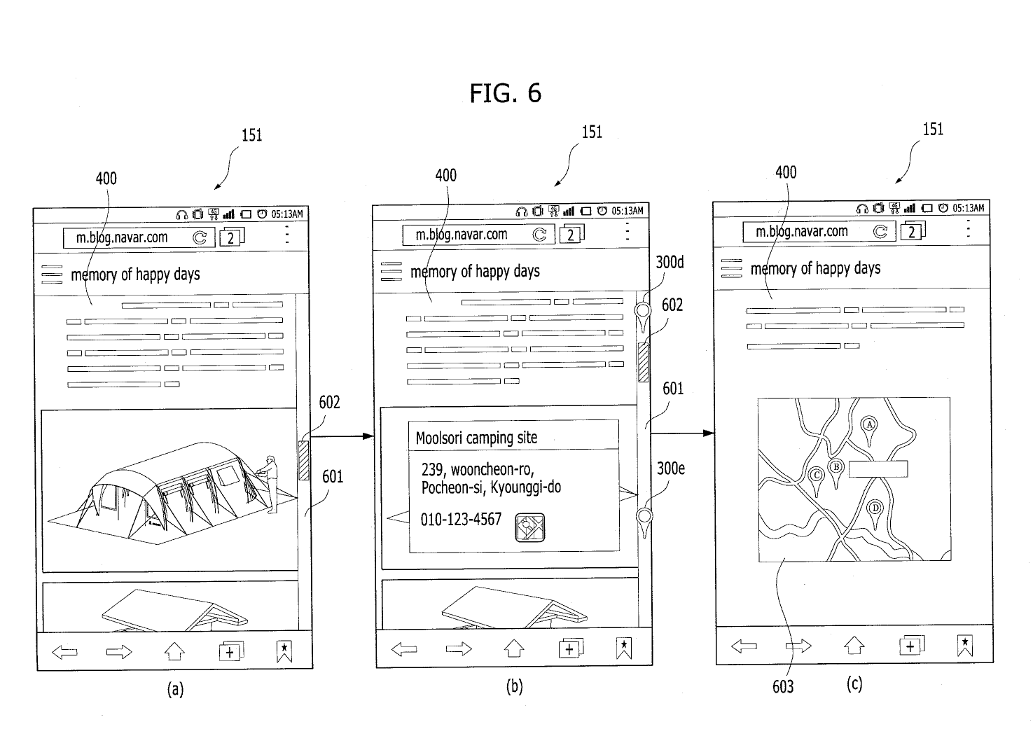

FIG. 6 is a diagram for a control method of displaying a location in which location information content is included on a scroll bar configured to scroll a web page according to one embodiment.

In general, when a web page (a page loaded by a URL) is outputted on a display, if a size of the web page exceeds a size of the display, a user can read an unseen part of the web page using a scroll function.

Referring to FIG. 6(a), a specific web page 400 is outputted via an execution screen 301 of a web browser application. In order to read the web page 400 deviating from an output range of the touch screen 151, a scroll bar 601 is outputted in an area of the execution screen 301.

A scroll bar corresponds to an indicator indicating a ratio of a size of a currently outputted web page to a size (length) of a whole web page. In the example shown in FIG. 6, a vertical length of a scroll bar corresponds to a vertical length of the whole web page and a scroll indicator 602 of the scroll bar corresponds to a vertical length of a web page currently displayed via the touch screen 151.

Referring to FIG. 6(b), the controller 180 can further display a location information indicator 300d/300e on a point of the scroll bar 601 corresponding to a point in which location information is included in the web page 400 in response to a prescribed touch gesture. If the location information indicator 300 displayed on the scroll bar 601 is selected, as mentioned earlier with reference to FIG. 3, it may be able to output a preview 304.

Referring to FIG. 6(c), moreover, if the selected location information indicator 300d/300e is additionally selected, the controller 180 moves the scroll to a location corresponding to the location information indicator 300d/300e selected on the web page 400 and may be able to output the location. In the example shown in FIG. 6(C), location information 603 is outputted in a map type.

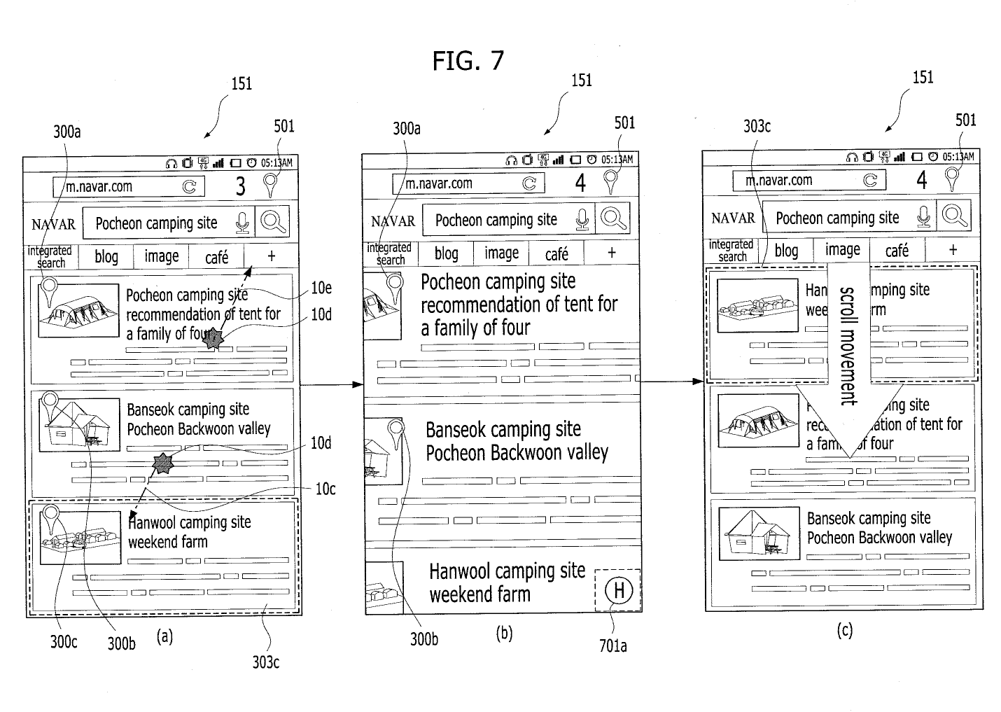

In the embodiment mentioned earlier with reference to FIG. 3 and FIG. 4, it is proposed to display the location information indicator 300 on a search list together. The search list may deviate from an output range of the touch screen 151 as well. In this case, a control method capable of easily accessing the location information indicator 300 is explained in the following with reference to FIG. 7.

FIG. 7 is a diagram for a control method of separately displaying a location information indicator for a search list deviating from an output range of a touch screen 151 according to one embodiment.

Referring to FIG. 7(a), the controller 180 outputs a search list via a web search engine and displays a location information indicator 300 on an item of the search list. And, as mentioned earlier with reference to FIG. 5, the controller further displays the number 501 of the location information indicators 300 included in the search list. Referring to an example shown in FIG. 7, the number of the location information indicators included in the search list corresponds to ‘3’.

The controller 180 can output the search list in a manner of enlarging the search list in response to a pinch out touch gesture 10d/10e. If a position on which the location information indicator 300 is displayed corresponds to a position of a corresponding item on the search list, a part/all of the location information indicator 300 may deviate from an output range due to the enlargement of the search list.

Referring to FIG. 7(b), if an outputted third location information indicator 300c deviates from an output range of the touch screen 151 due to the operation of enlargement, the controller 180 can separately output a hide indicator 701a in an area of the touch screen 151 to indicate that the third location information indicator 300c deviates from the output range of the touch screen. In particular, the controller can display the hide indicator 701a to notify that a display of the third location information indicator 300c, which is used to be displayed on a third web page item 303c, is hidden.

Referring to FIG. 7(c), if an input for selecting the hide indicator 701a is received, the controller 180 can automatically move a scroll to a position of the corresponding item 303c.

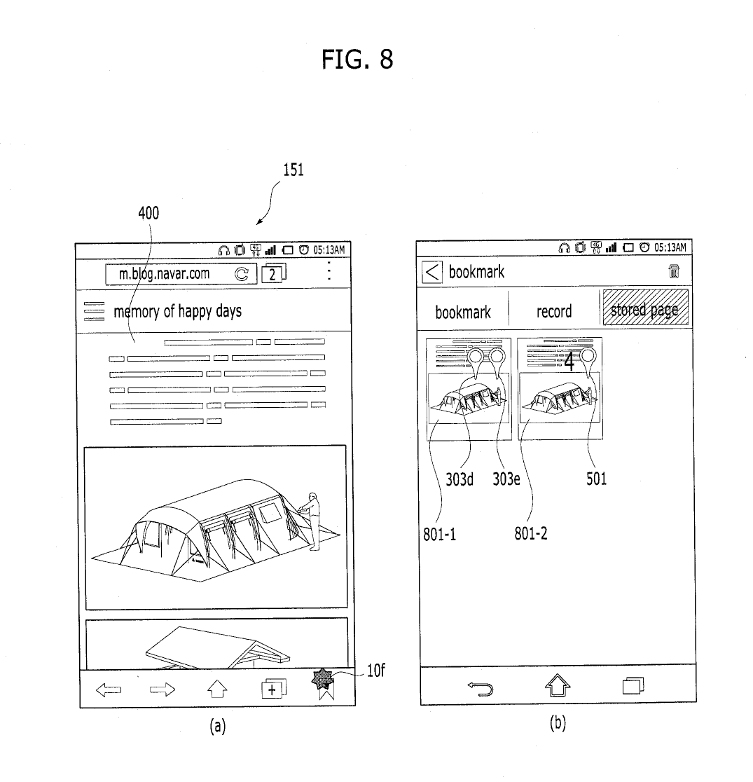

Meanwhile, a web browser application provides a function of separately storing a web page and contents of the web page in a mobile terminal 100 and a function of reading the stored contents again in the future (“offline view” function). In particular, in case of reading an identical web page again in the future, the web page can be loaded and outputted using the stored contents without accessing a corresponding server and receiving the contents again. If location information is stored using the aforementioned function, one embodiment further proposes a control method of notifying that the location information is stored together. Regarding this embodiment, it shall be explained with reference to FIG. 8 in the following.

FIG. 8 is a diagram for a control method of guiding location information included in a web page in case that the web page is stored by “offline view” function according to one embodiment.

Referring to FIG. 8(a), the controller 180 outputs a prescribed web page 400. If an input 10f for touching a store icon is received, the controller 180 can store the outputted prescribed web page 400 and contents included in the web page in the memory 170.

Referring to FIG. 8(b), it shows a state of reading web pages stored in the memory 170. Each item 801-1/801-2 of the stored web pages is outputted. In the example shown in FIG. 8, assume that location information is included in each of the stored web pages. The controller 180 can further display a location information indicator 303d/303e on each item 801-1/801-2. In particular, in order for a user to check whether location information is included in each item 801-1/801-2 of the stored web pages, the user may check the location information indicator 303d/303e.

And, if a great amount of location information is included in each item, it is able to differently display the number of the location information indicators according to the number of the location information. The number of the location information indicators can be displayed by a number 501.

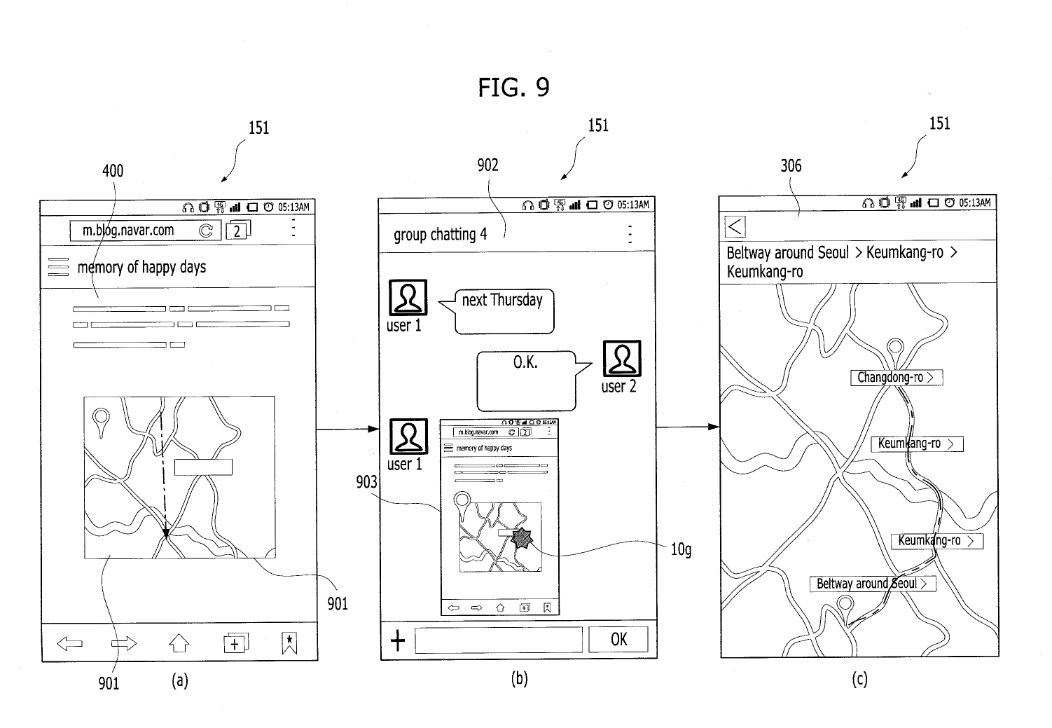

Meanwhile, one embodiment further proposes a control method of copying location information content in response to a content copy command of a user. Regarding this embodiment, it shall be described with reference to FIG. 9 in the following.

FIG. 9 is a diagram for a control method of transmitting location information content included in a prescribed content together in case that the prescribed content is transmitted to a different mobile terminal according to one embodiment.

Referring to FIG. 9(a), the controller 180 outputs a web page 400 via the touch screen 151. Location information is included in the outputted web page 400 and the location information is outputted in a map type.

In case of delivering a screen of the location information, which is displayed in the map type, to a different mobile terminal, a user can input a screen capture command including a designation of a prescribed area 901.

Referring to FIG. 9(b), if the capture command is received, the controller 180 can store not only image content of which the screen of the location information is captured but also corresponding location information content. And, if the stored image content is transmitted to a different mobile terminal, the corresponding location information content can be transmitted as well.

FIG. 9(b) shows a state of a message application 902 configured to transmit the location information content as well as the image content 903.

Referring to FIG. 9(c), if an input 10g for selecting the image content 903 is received, the controller 180 can output corresponding location information content 306.

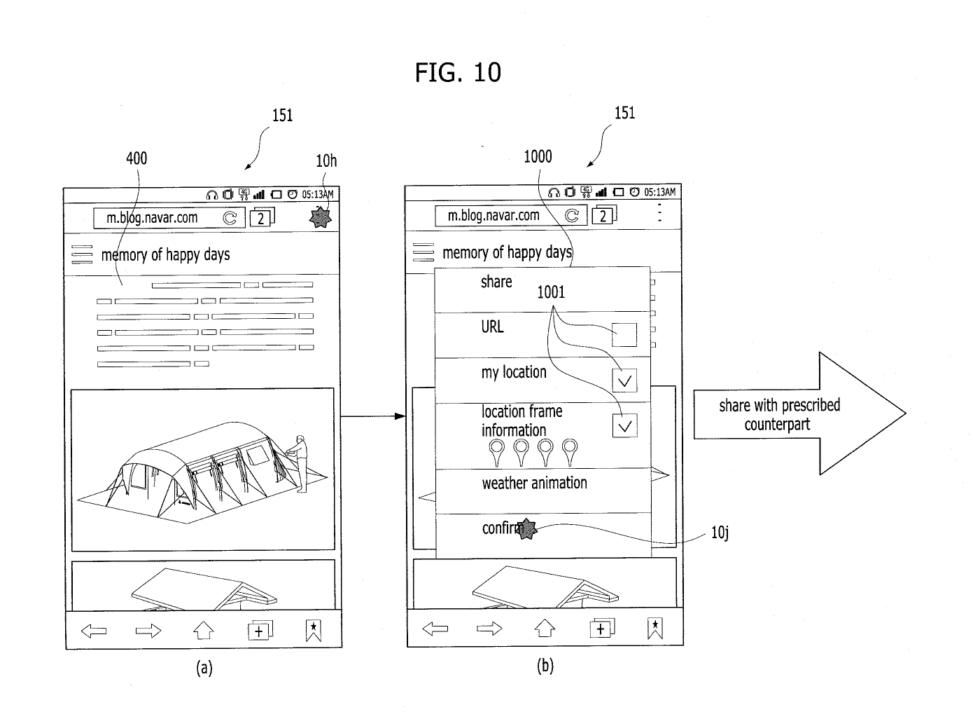

In the embodiment mentioned earlier with reference to FIG. 9, although a prescribed area 901 of a web page is designated and the prescribed area is transmitted to a different mobile terminal, it may be able to transmit a whole of the web page. Regarding this embodiment, it shall be described in the following with reference to FIG. 10.

FIG. 10 is a diagram for a control method of selectively transmitting a web page 400 and content included in the web page according to one embodiment.

Referring to FIG. 10(a), a prescribed web page 400 is outputted via an execution screen of a web browser application. If an input 10h for selecting a prescribed icon on the outputted web page 400 is received, the controller 180 can output a content selection pop-up window 1000 capable of selecting a plurality of contents.

Referring to FIG. 10(b), the content selection pop-up window outputs a check box 1001 according to a plurality of content items. If a prescribed item is checked via the check box 1001 and a confirmation 10j is selected, the controller 180 can share a part of selected contents or all of the selected contents with a different user together with the web page 400.

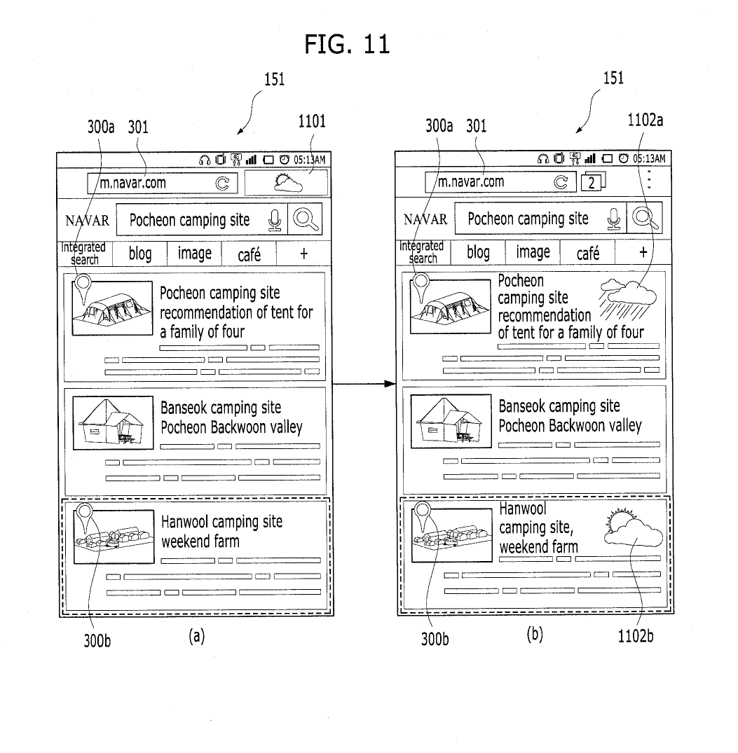

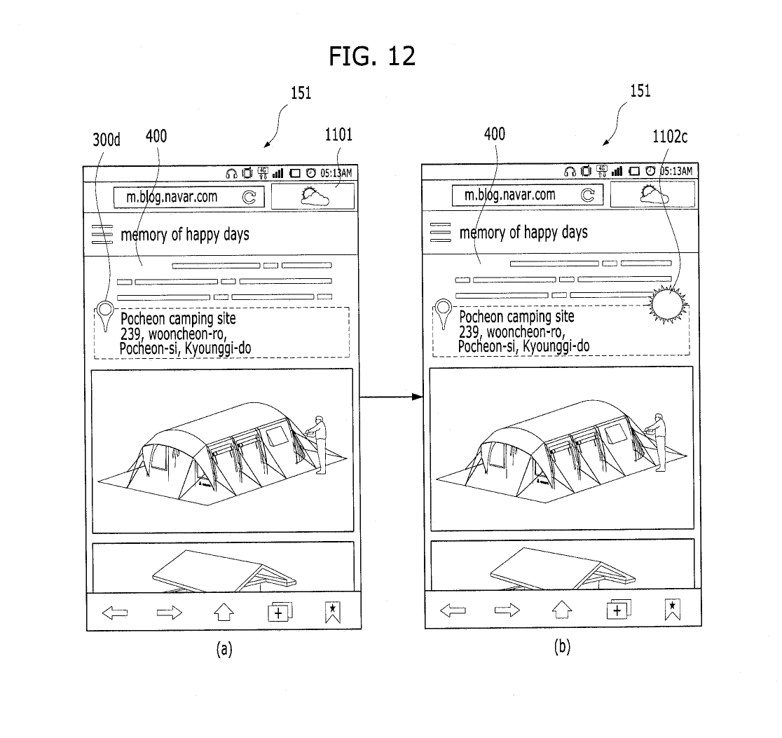

Meanwhile, if location information and weather information are used together, it may be useful. In the following, a control method of outputting weather information is explained with reference to FIG. 11 and FIG. 12.

FIGS. 11 and 12 are diagrams for a control method of providing weather information corresponding to location information together with the location information according to one embodiment.

Since weather information may vary according to a geographical location, the weather information is generally provided along with location information.

Referring to FIG. 11(a), a location information indicator 300 is outputted together with a search list mentioned earlier in the aforementioned embodiment.

Referring to FIG. 11(b), if a prescribed command is received, the controller 180 can output the location information indicator 300 and a weather indicator 1102a/1102b indicating weather of a geographical location corresponding to the location information indicator.

Referring to FIG. 12(a), a location information indicator 300d is displayed on a web page 400 together with the web page.

Referring to FIG. 12(b), if a prescribed command is received, the controller 180 can output a weather indicator 1102c indicating weather information of a location corresponding to the location information indicator 300d.

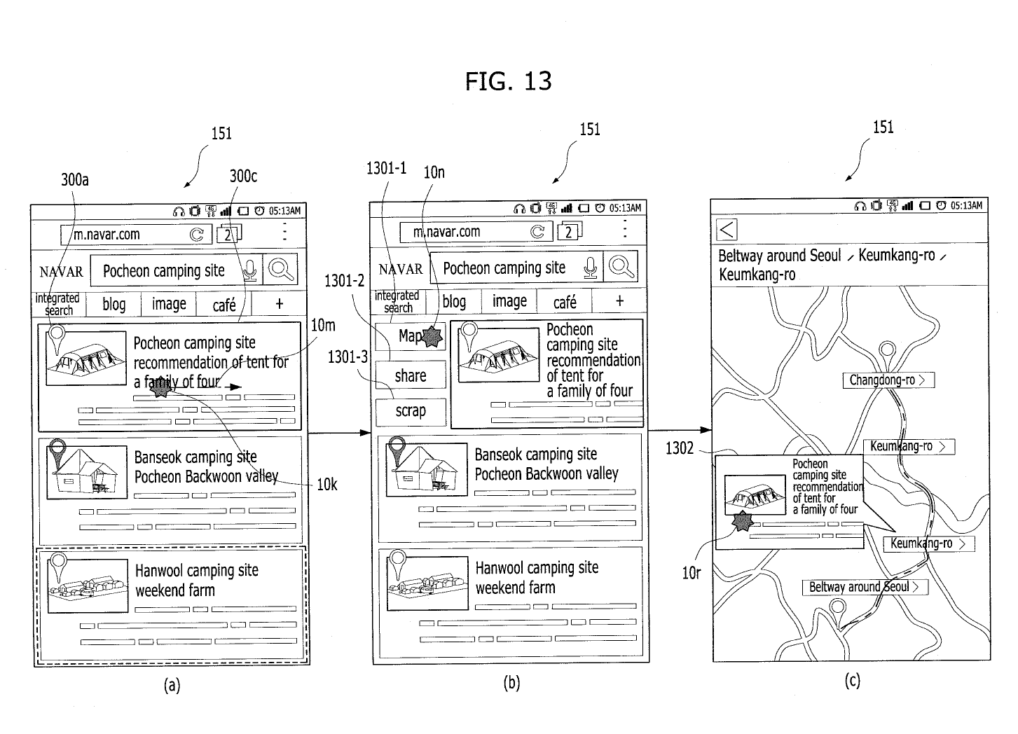

A different embodiment proposes a different control method of enabling a user to easily access location information which is provided with a search list. The different control method is explained in the following with reference to FIG. 13.

FIG. 13 is a diagram for a control method enabling a user to directly access location information provided on a search list according to one embodiment.

Referring to FIG. 13(a), a state of outputting a location information indicator 300a together with a search list is shown. The controller 180 can display at least one or more function icons 1301-1 to 1301-3 in response to a prescribed touch gesture 10k/10m received on a prescribed item 303c.

Referring to FIG. 13(b), if an input 10m for selecting a first function icon 1301-1 (map) is received, the controller 180 can output a map in a manner of interworking with a map application and display a corresponding location in a manner of identifying the location on the map.

Referring to FIG. 13(c), it may be able to include a pop-up window 1302 including a thumbnail of a web page on the interlocked map application. If an input 10r for touching the pop-up window is received, the controller 180 can return to an execution screen of a web browser application outputting the web page 400.

Referring to FIG. 13(c), if a second function icon 1301-2 (sharing) is selected, the controller 180 can share a corresponding web page item with a different mobile terminal. If a third function icon 1301-3 (scrap) is selected, the controller 180 can control a corresponding web page item to be stored in the memory 170.

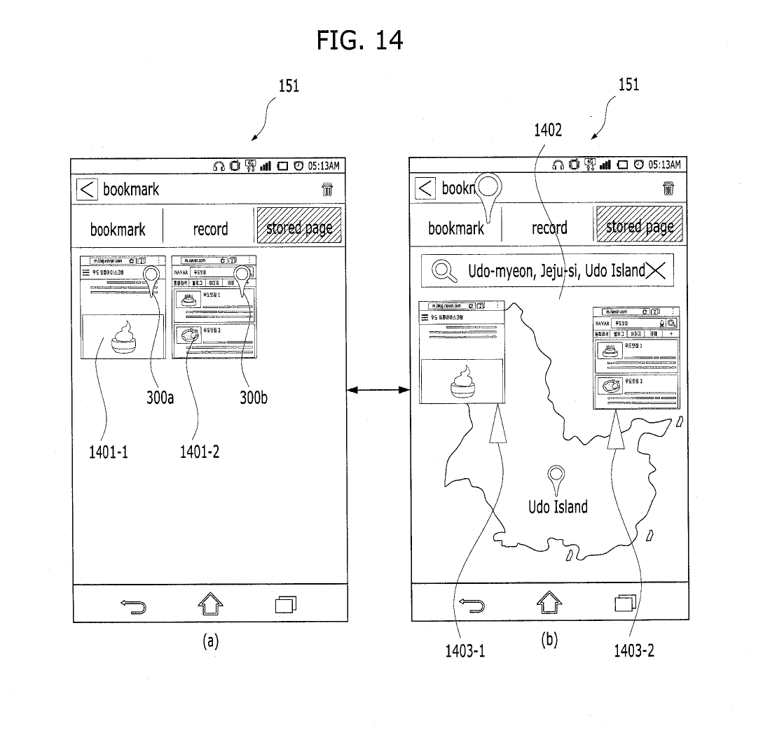

FIG. 14 is a diagram for a control method of reading a web page item stored in a memory 170.

FIG. 14(a) shows a web page item outputted in a list type and FIG. 14(b) shows a web page item outputted in a map type in case of outputting a stored web page item.

Referring to FIG. 14(a), web page item 1401-1/1401-2 for each web page stored in the memory 170 is outputted. Each web page item 1401-1/1401-2 may be able to display a location information indicator 300a/300b according to location information content stored together with the web page item.

Referring to FIG. 14(b), each web page item 1403-1/1403-2 can be outputted on a location corresponding to the each location information on a map. A user may be able to easily access a stored web page item on the map.

According to one embodiment, if there exists location information stored in the memory 170 and a current location of a detected mobile terminal corresponds to a location corresponding to the stored location information, the aforementioned method can further provide a notification to a user. The notification may correspond to a notification notifying that the current location of the mobile terminal is near the location information included in the stored web page.

In the aforementioned embodiment, a case of storing location information in advance on a prescribed web page 400 has been explained. In the following embodiment, a control method of storing location information on a prescribed web page 400 is explained.

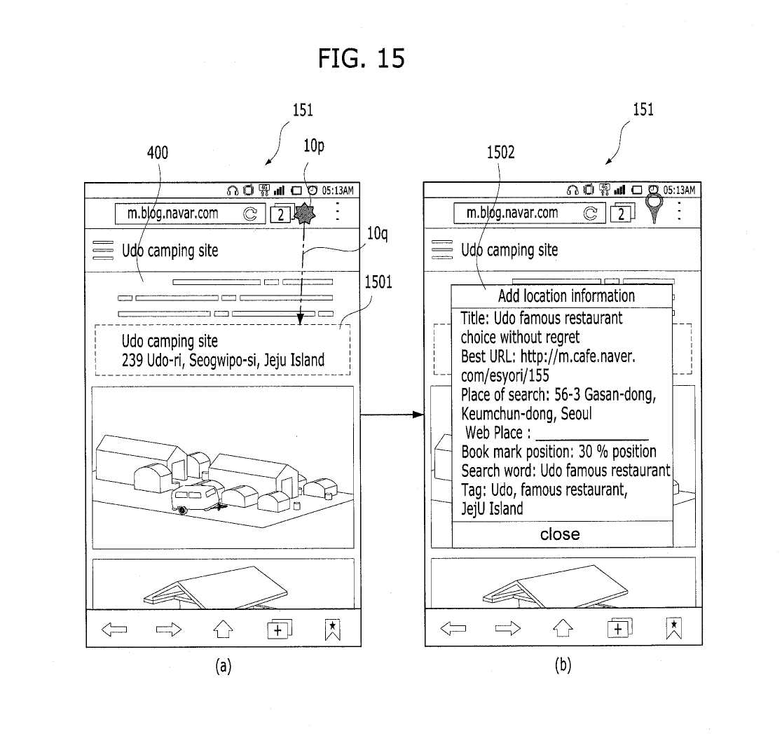

FIG. 15 is a diagram for a control method of storing location information corresponding to a prescribed web page 400 by a user input according to one embodiment.

Referring to FIG. 15(a), the controller 180 outputs a prescribed web page 400 via the touch screen 151. The web page 400 includes a prescribed address text 1501.

Referring to FIG. 15(b), if a prescribed touch gesture 10p is received in relation to the address text 1501, the controller 180 can output a pop-up window 1502 to add location information. A user can input such information as a title, URL, a search word and the like together with location information via the pop-up window 1502. The prescribed touch gesture 10p/10q may correspond to a gesture touching 10p a location information add icon and dragging 10q the icon to the address text 1501.

In the aforementioned embodiment described with reference to FIG. 15, a control method of manually storing location information has been explained, by which embodiments may be non-limited. The location information can be automatically stored. The controller 180 can automatically determine and store location information in a manner of analyzing a title of a prescribed web page 400, text information included in the text, metadata (GPS information) of an image data, map information included in a web page and the like.

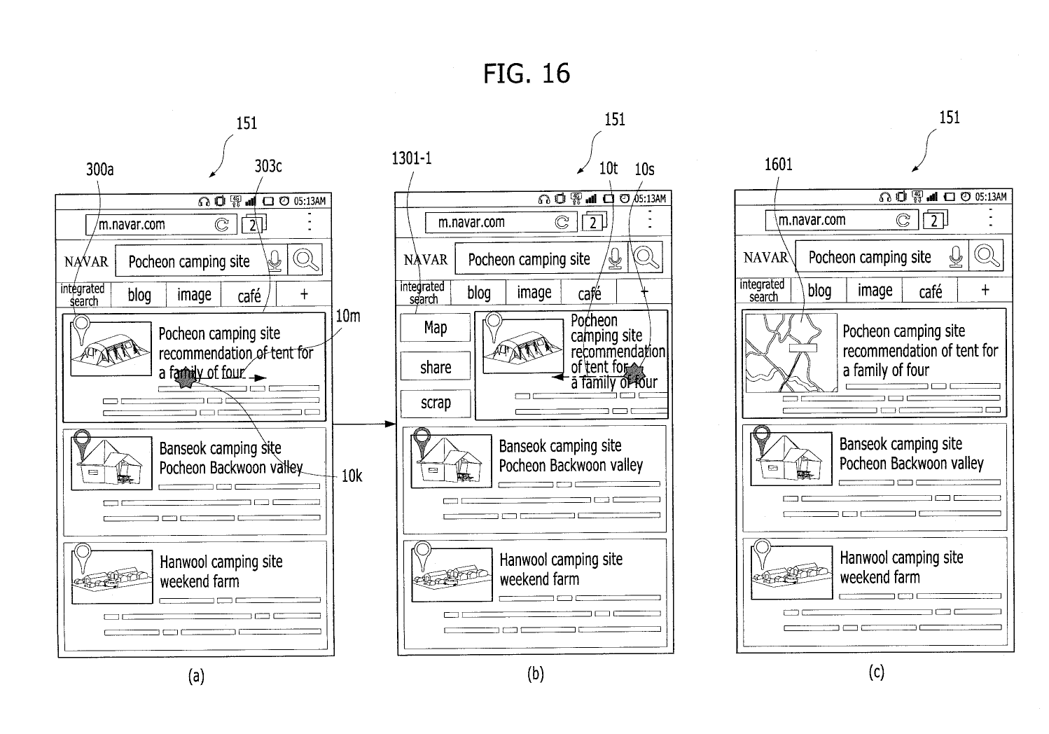

FIG. 16 is a diagram for a control method enabling a user to directly access location information provided on a search list according to a different embodiment.

Referring to FIG. 16(a), a state of outputting a location information indicator 300a together with a search list is shown. The controller 180 can display at least one or more function icons 1301-1 to 1301-3 in response to a prescribed touch gesture 10k/10m received on a prescribed item 303c.

Referring to FIG. 16(b), if an input 10m for selecting a first function icon 1301-1 (map) is received, the controller 180 can output a map in a manner of interworking with a map application and display a corresponding location in a manner of identifying the location on the map.

Referring to FIG. 16(c), the controller 180 outputs a map 1601 on a prescribed area of the prescribed item 303c in response to an additional touch gesture 10s/10t received on the prescribed item 303c and may be able to distinctively display corresponding location information on the outputted map 1601. In this case, as an example, the additional touch gesture may correspond to a gesture touching 10s the prescribed item 303c and dragging 10t the prescribed item in a left direction while maintaining the touch 10s.

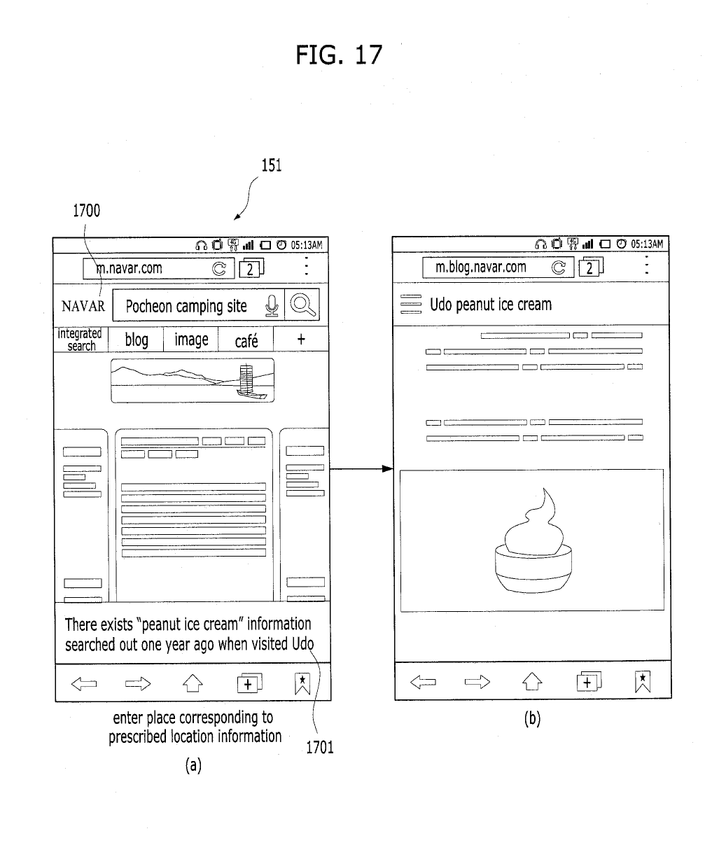

FIG. 17 is a diagram for a control method of providing a notification of location information to a user based on a current location of a mobile terminal 100 according to one embodiment.

Referring to FIG. 17(a), an execution screen 1700 of a prescribed application displayed via the touch screen 151 is shown. A mobile terminal 100 can determine whether there exists information matched with location information stored in the memory 170 based on a current location of the mobile terminal detected by the location information module 115. If there exists location information matched with the location information stored in the memory, the controller can output a notification 1701 to notify that there exists the location information matched with the location information stored in the memory.

Referring to FIG. 17(b) if an input for selecting the notification 1701 is received, the controller 180 can outputs a corresponding web page 400. In this case, if the corresponding web page 400 is stored in the memory 170, the controller may be able to load the stored web page 400 or may be able to output a new search result using corresponding keyword information only.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal. The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments. As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

It will be apparent to those skilled in the art that various modifications and variations can be made in the embodiments without departing from the spirit or scope of the disclosure. Thus, it is intended that the disclosure covers the modifications and variations of this disclosure provided they come within the scope of the appended claims and their equivalents.

One object is to solve the aforementioned problem and a different problem. Another object is to provide a mobile terminal enabling a user to easily read a web page including location information and a method of controlling therefor.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, according to one embodiment, a mobile terminal includes a touch screen configured to output an execution screen of a web browser application and a controller configured to receive a text input in a search field of the web browser application, the controller configured to transmit a query to a web search engine based on the text input, the controller configured to receive at least one or more web search results from the web search engine in response to the query, the controller configured to control the touch screen to display a web search list including the at least one or more web search results within the web browser application and a location information indicator on a prescribed item of the outputted web search list. In this case, the location information indicator corresponds to an indicator indicating whether location information is included in the web search result.

To achieve these objects and other advantages and in accordance with the purpose of the disclosure, as embodied and broadly described herein, according to a different embodiment, a method of controlling a mobile terminal includes the steps of outputting an execution screen of a web browser application, receiving a text input in a search field of the web browser application, transmitting a query to a web search engine based on the text input, receiving at least one or more web search results from the web search engine in response to the query and controlling the touch screen to display a web search list containing the at least one or more web search results and a location information indicator on a prescribed item of the outputted web search list. In this case, the location information indicator corresponds to an indicator indicating whether location information is included in the web search result.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal, comprising:
a touch screen configured to output a screen of a web browser application; and
a controller configured to provide a search query to a web search engine based on an input at a search field, to receive one or more web search results from the web search engine in response to the search query, to control the touch screen to display a web search list containing the one or more web search results and a location information indicator, the location information indicator to identify that location information is provided in the web search list.

2. The mobile terminal of claim 1, wherein the location information is address information.

3. The mobile terminal of claim 1, wherein the controller to display a total number of location information indicators corresponding to the web search list.

4. The mobile terminal of claim 1, wherein in response to receiving a selection of a prescribed item of the displayed web search list, the controller is configured to display a prescribed web page corresponding to the prescribed item.

5. The mobile terminal of claim 4, wherein in response to receiving a command for capturing an area of a web page containing the location information, the controller is configured to store the location information together with a screen capture image of the area of the web page.

6. The mobile terminal of claim 4, wherein the controller is configured to display, in an area of the displayed web page, a screen of a map application, and to distinctively display a location corresponding to the location information on the screen of the map application.

7. The mobile terminal of claim 1, wherein in response to receiving a selection of the location information indicator, the controller is configured to scroll to a point in which the location information is provided in a prescribed web page corresponding to the prescribed item and to display the point.

8. The mobile terminal of claim 7, wherein the controller is configured to distinctively display the point in which the location information is provided in the displayed web page.

9. The mobile terminal of claim 7, wherein the controller is configured to display a scroll bar, and to distinctively display, on the scroll bar, the point corresponding to the location information.

10. The mobile terminal of claim 1, wherein in response to selecting the location information indicator, the controller is configured to control the touch screen to display a preview of corresponding location information, and wherein the preview is displayed at a pop-up window or the preview is displayed between two items of the web search list.

11. The mobile terminal of claim 1, wherein the controller is configured to display, at a prescribed item of the displayed web search list, a weather indicator corresponding to the location information.

12. The mobile terminal of claim 1, wherein the controller is configured to display, in a control region, at least one or more function icons of the web browser application, and to display, at the control region, a total number of location information indicators in the web search list.

13. A method of controlling a mobile terminal, comprising:
displaying a screen of a web browser application;
receiving an input at a search field of the web browser application;
providing a search query to a web search engine based on the input;
in response to the search query, receiving one or more web search results from the web search engine; and
controlling the touch screen to display a web search list containing the one or more web search results and a location information indicator, the location information indicator to identify that location information is provided in the web search list.

14. The method of claim 13, wherein the location information is address information.

15. The method of claim 13, further comprising displaying a total number of location information indicators corresponding to the web search list.

16. The method of claim 13, further comprising:
receiving a selection of a prescribed item of the displayed web search list; and
displaying a prescribed web page corresponding to the selected prescribed item.

17. The method of claim 16, further comprising:
receiving a command for capturing an area of a web page containing the location information; and
storing the location information together with a screen capture image of the area of the web page.

18. The method of claim 16, further comprising:
displaying, at an area of the displayed web page, a screen of a map application; and
distinctively displaying, on the screen of the map application, a location corresponding to the location information.

19. The method of claim 13, further comprising:
receiving a selection of the location information indicator; and
scrolling to a point in which the location information is provided in a prescribed web page corresponding to the prescribed item and displaying the point.

20. The method of claim 19, further comprising distinctively displaying the point in which the location information is provided in the displayed web page.

21. The method of claim 19, further comprising:
displaying a scroll bar; and
distinctively displaying, on the scroll bar, the point corresponding to the location information.

22. The method of claim 13, further comprising:
receiving a selection of the location information indicator; and
displaying a preview of corresponding location information,
wherein the preview is displayed at a pop-up window or the preview is displayed between two items of the web search list.

23. The method of claim 13, further comprising displaying, at a prescribed item of the displayed web search list, a weather indicator corresponding to the location information.

24. The method of claim 13, further comprising:
displaying, at a control region, at least one or more function icons of the web browser application; and
displaying, at the control region, a total number of location information indicators in the web search list.
